(19) United States
(12) Patent Application Publication
(10) Pub. No.: US 2015/0037085 A1
(43) Pub. Date: Feb. 5, 2015

(54) ROTARY COUPLING

(71) Applicant: Jeffrey D. Carnevali, Seattle, WA (US)

(72) Inventor: Jeffrey D. Carnevali, Seattle, WA (US)

(21) Appl. No.: 13/957,292

(22) Filed: Aug. 1, 2013

Related U.S. Application Data
(60) Provisional application No. 61/860,514, filed on Jul. 31, 2013.

(51) Int. Cl. F16C 11/10; F16M 13/02

(52) U.S. Cl. CPC F16C 11/10; F16M 13/02
USPC 403/103

(57) ABSTRACT

A rotary coupling having first and second mounting interfaces. The rotary coupling also having a rotary joint rotatably connecting the first and second interfaces in preselected rotational orientation, wherein the rotary joint has selectively engageable redundant engaging means for interengaging the first and second interfaces for maintaining a preselected one of a plurality of alternate rotational orientations. According to one embodiment, the selectively engageable redundant engaging means of the rotary coupling further includes a plurality of interengageable detents.

### FIELD OF THE INVENTION

The present invention relates to a rotary coupling for selectively engaging two external bodies in different preselected rotational orientations, and in particular to a rotary joint having selectively engageable redundant engaging means for interengaging the first and second interfaces for maintaining a preselected one of a plurality of alternate rotational orientations.

### BACKGROUND OF THE INVENTION

Mounting adapters for electronic tablets and similar electronic devices are generally well known. These mounting adapters provide a means for supporting the electronic device in a position for viewing the display screen.

However, known mounting adapters for such electronic devices are limited in their ability to provide complete access to operate the electronic device efficiently and reliably.

### SUMMARY OF THE INVENTION

The present invention is a rotary coupling for selectively engaging two external bodies in different preselected rotational orientations. The two external bodies may be, by example and without limitation, a cradle for presenting a display screen and a stanchion or other support member for supporting the cradle in a desired location. The rotary coupling of the invention provides for rotation of the cradle and display screen between a plurality of different rotational orientations, including but not limited to upright or portrait orientation and horizontal or landscape orientation.

According to one aspect of the invention, the rotary coupling includes first and second mounting interfaces; and a rotary joint that rotatably connects the first and second interfaces in a preselected rotational orientation, wherein the rotary joint has selectively engageable redundant engaging means for interengaging the first and second interfaces for maintaining a preselected one of a plurality of alternate rotational orientations.

According to another aspect of the invention, the selectively engageable redundant engaging means of the rotary coupling further includes a plurality of interengageable detents.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 and FIG. 2 are perspective views showing an example of an application of the rotary coupling of the invention, wherein FIG. 1 shows a display in a portrait view orientation, and

FIG. 2 shows the same display in a landscape view orientation;

FIG. 3 and FIG. 4 together illustrate operation of the rotary coupling of the invention for rotating the same display between a plurality of different rotational orientations, wherein FIG. 3 shows a display in a portrait view orientation, and

FIG. 4 shows the same display in a landscape view orientation;

FIG. 5 illustrates operation of the rotary coupling of the invention for translating the same display between a plurality of different linear positions on a support member;

FIG. 6 is a rear view of the rotary coupling of the invention showing an optional rigid cap having additional mounting capability beyond capturing of stanchion or other support member;

FIG. 7 and FIG. 8 illustrate one example of the rotary coupling of the invention positioned between a cradle holding the same display and the stanchion or other support member, wherein the rotary coupling includes a pair of mounting interfaces with one mounting interface being adapted for connecting to the stanchion or other support member, while the other mounting interface is adapted for receiving the same display cradle;

FIG. 9 illustrates one mounting interface of rotary coupling of the invention, wherein one interfacing surface of a flange portion thereof includes notches as one part of an interengageable detent-type engaging means that is operable between the pair of mounting interfaces;

FIG. 10 is an exploded view of the rotary coupling of the invention with the optional rigid cap being removed for clarity; and

FIG. 11 and FIG. 12 illustrate operation of the rotary coupling of the invention between mating of pawls and notches of the interengageable detent-type engaging means formed in respective juxtaposed interfacing surfaces of the pair of mounting interfaces.

### DETAILED DESCRIPTION OF PREFERRED EMBODIMENT

As required, a detailed illustrative embodiment of the present protective enclosure is disclosed herein. However, techniques, systems and operating structures in accordance with the present protective enclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present protective enclosure. The following presents a detailed description of an illustrative embodiment (as well as some alternative embodiments) of the present protective enclosure.

In the Figures, like numerals indicate like elements.

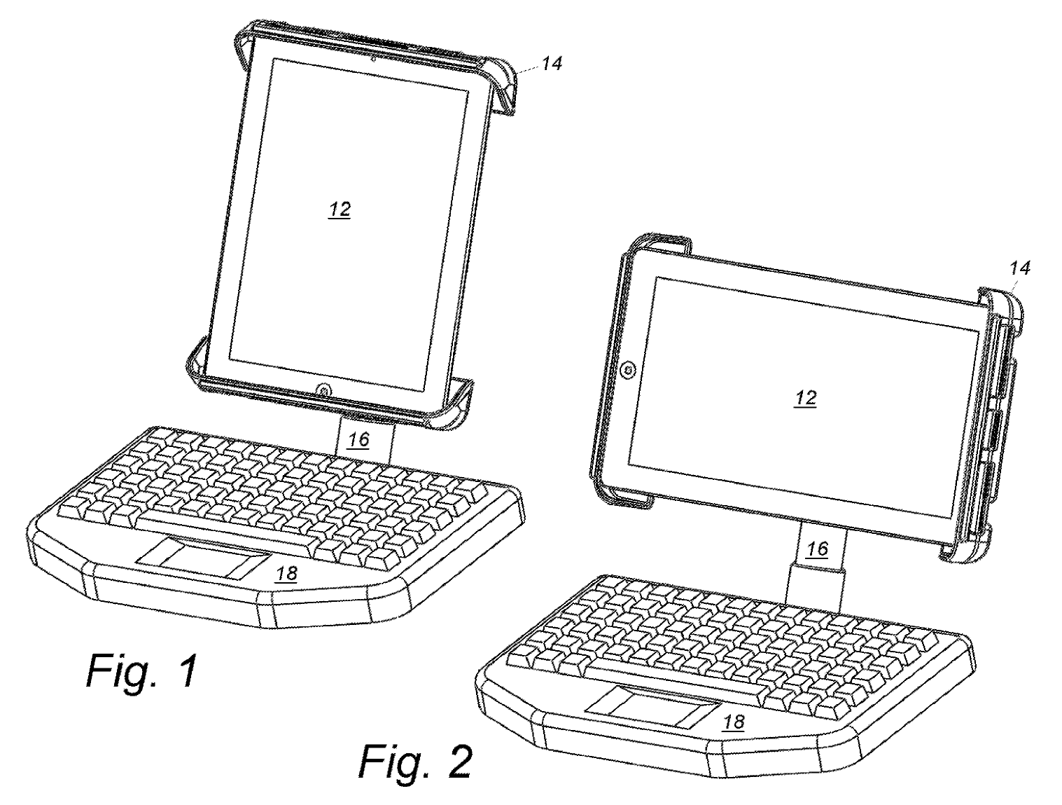

FIG. 1 and FIG. 2 together illustrate operation of a rotary coupling 10 for rotating a display 12 or other object between a plurality of different rotational orientations. Here, FIG. 1 shows display 12 in a portrait view orientation in a cradle 14 on a stanchion or other support member 16, while FIG. 2 illustrates the same display 12 in a landscape view orientation.

Here, by example and without limitation, cradle 14 is mounted on rotary coupling 10. Such cradle is only by example and is not intended to imply any limitation on applications for rotary coupling 10.

FIGS. 1 and 2 also illustrate a keyboard 18 being presented adjacent to cradle 14 presenting display 12.

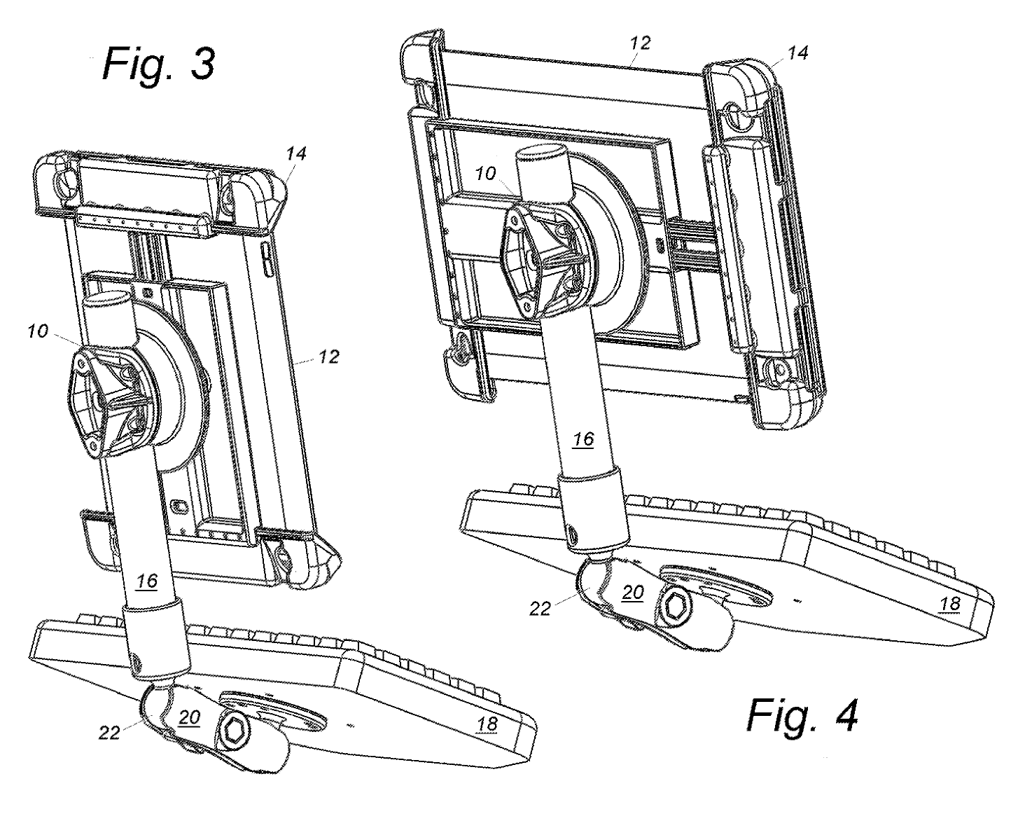

FIG. 3 and FIG. 4 together illustrate operation of rotary coupling 10 for rotating display 12 or other object between a plurality of different rotational orientations. Here, FIG. 3 shows display 12 in a rear portrait view orientation in cradle 14 on stanchion or other support member 16, while FIG. 4 illustrates same display 12 in a rear landscape view orientation. Here, by example and without limitation, keyboard 18 is mounted on a second stanchion or other support member 20 coupled to stanchion 16 holding display 12 in cradle 14. Optionally, an adjustable ball-and-socket joint 22 couples first and second support members 16, 20.

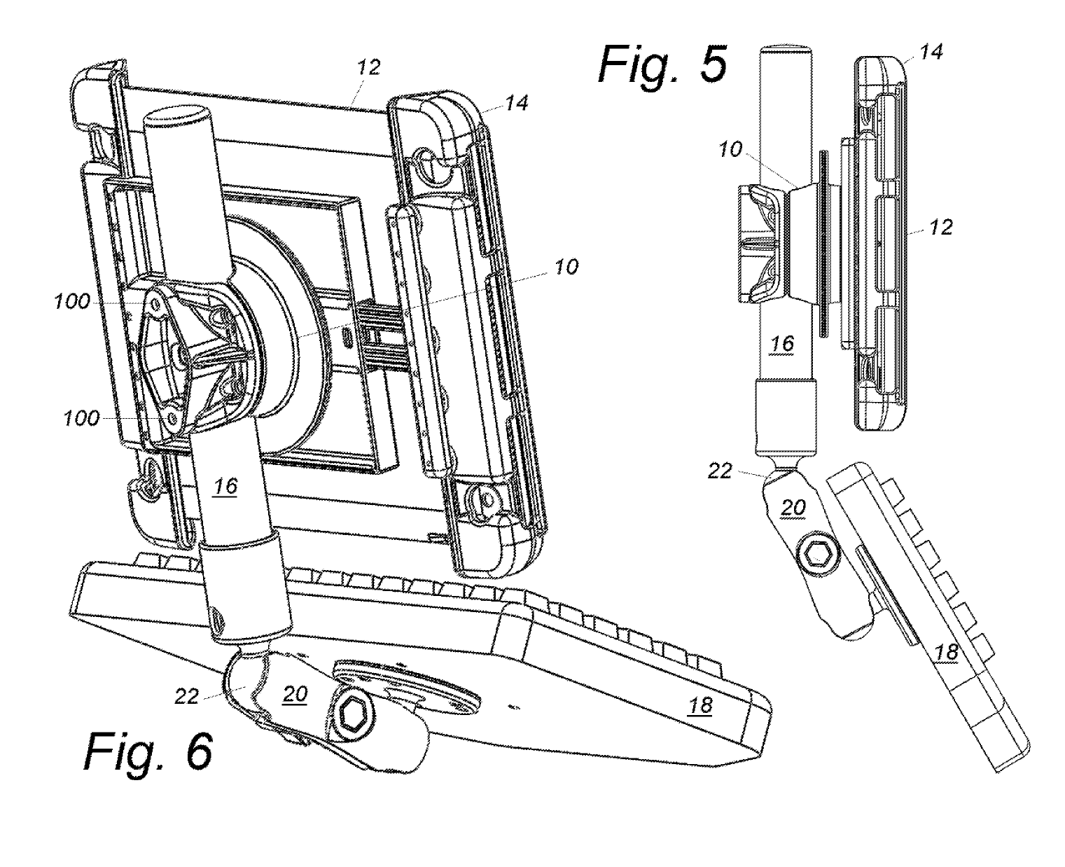

FIG. 5 illustrates operation of rotary coupling 10 for moving display 12 or other object between a plurality of different linear positions on support member 16. Here, cradle 14 holding display 12 is translated along stanchion or other support member 16 to different position closer to second support member 20 and keyboard 18 mounted thereon. For example, rotary coupling 10 includes a rigid cap 110 for capturing stanchion or other support member 16 and securing rotary coupling 10 thereto. Loosening rigid cap 110 permits translation of rotary coupling 10 along stanchion 16.

FIG. 6 is a rear view showing rigid cap 110 having additional mounting capability beyond capturing of stanchion or other support member 16. By example and without limitation, rigid cap 110 includes a pair of mounting holes 100 that permit direct mounting to an external surface.

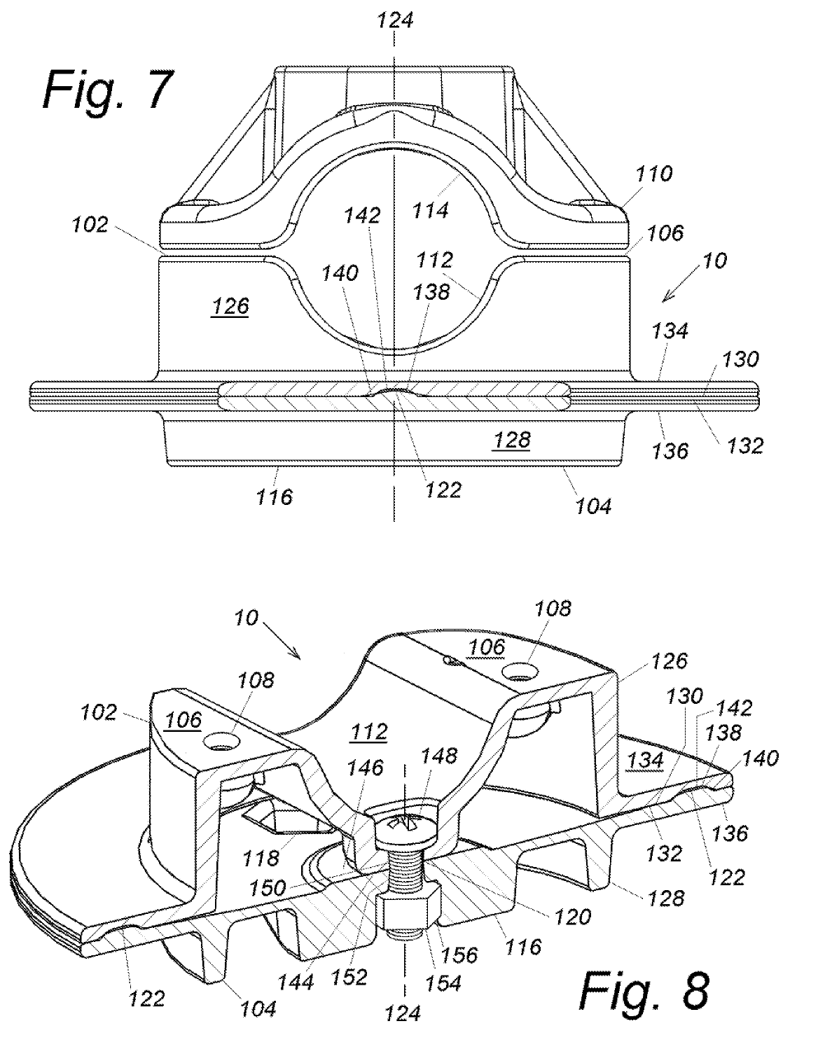

FIG. 7 and FIG. 8 illustrate one example of rotary coupling 10 interposed between cradle 14 holding display 12 and stanchion or other support member 16, as disclosed herein. Rotary coupling 10 includes a pair of mounting interfaces 102 and 104. One mounting interface 102 is adapted for connecting to stanchion or other support member 16. For example, mounting interface 102 is formed with one or more substantially planar and coplanar mounting surfaces 106 pierced with one or more fastener apertures 108 in positions for receiving fasteners. As disclosed herein, an optional rigid cap 110 is coupled to mounting interface 102 by fasteners mated with fastener apertures 108 for securing cap 110 to mounting interface surface 106. According to one embodiment, mounting interface 102 optionally includes a valley 112 for receiving stanchion or other support member 16; cap 110 optionally includes a cooperating valley 114 also for receiving stanchion member 16. Together, mounting interface 102 and rigid cap 110 effectively capture stanchion member 16 between cooperating valleys 112, 114, whereupon fasteners secure rigid cap 110 to mounting interface 102 with stanchion member 16 clamped in cooperating valleys 112, 114. Loosening clamping fasteners permits rotary coupling 10 to slide along length of stanchion member 16 to any desired position there along. With rotary coupling 10 in a desired position along stanchion member 16, stanchion member 16 is again clamped in cooperating valleys 112, 114.

Alternatively, fastener apertures 108 in mounting interface 102 provide optional additional mounting capability different from mounting holes 100 of rigid cap 110. For example, fastener apertures 108 permit direct mounting of mounting interface 102 to an external surface. Accordingly, rigid cap 110 and mounting holes 100 thereof are optional and may not be present.

As disclosed herein, mounting interface 104 is similarly formed with a substantially planar surface 116 pierced with one or more fastener apertures 118 in positions for receiving fasteners.

A rotary joint 120 rotatably couples mounting interfaces 102 and 104 in preselected rotational orientation, wherein rotary joint 120 has selectively engageable redundant engaging means 122 for interengaging mounting interfaces 102 and 104 for maintaining a preselected one of a plurality of alternate rotational orientations about a central axis 124 of rotary coupling 10. For example, here mounting interfaces 102 and 104 are formed with different cooperating body portions 126 and 128 of rotary coupling 10, wherein mounting interface 102 is formed with body portion 126, while mounting interface 104 is formed with body portion 128.

Body portion 126, 128 of respective mounting interfaces 102, 104 include engaging means 122, for example, provided by a plurality of interengageable detents between juxtaposed interfacing surfaces 130 and 132 of respective body portions 126, 128. Here, by example and without limitation, body portions 126, 128 are formed with adjacent annular flanges 134 and 136, respectively, that are formed with respective juxtaposed interfacing surfaces 130 and 132 having interengageable detent-type engaging means 122 are formed therebetween. Detent-type engaging means 122 include a zone 138 of interference between mating pawls 142 and notches 140 formed in respective juxtaposed interfacing surfaces 132, 130.

As illustrated here by example and without limitation, rotary joint 120 is formed of mutually slidable juxtaposed portions 144 and 146 of respective mounting interfaces 102, 104 coupled by a pivot 148 through a pair of mutually aligned apertures 150 and 152 formed along central axis 124, whereby mounting interfaces 102, 104 are rotatable about central axis 124. For example, pivot 148 is a threaded fastener coupled with a mating nut 154, for example, set in a nut pocket 156.

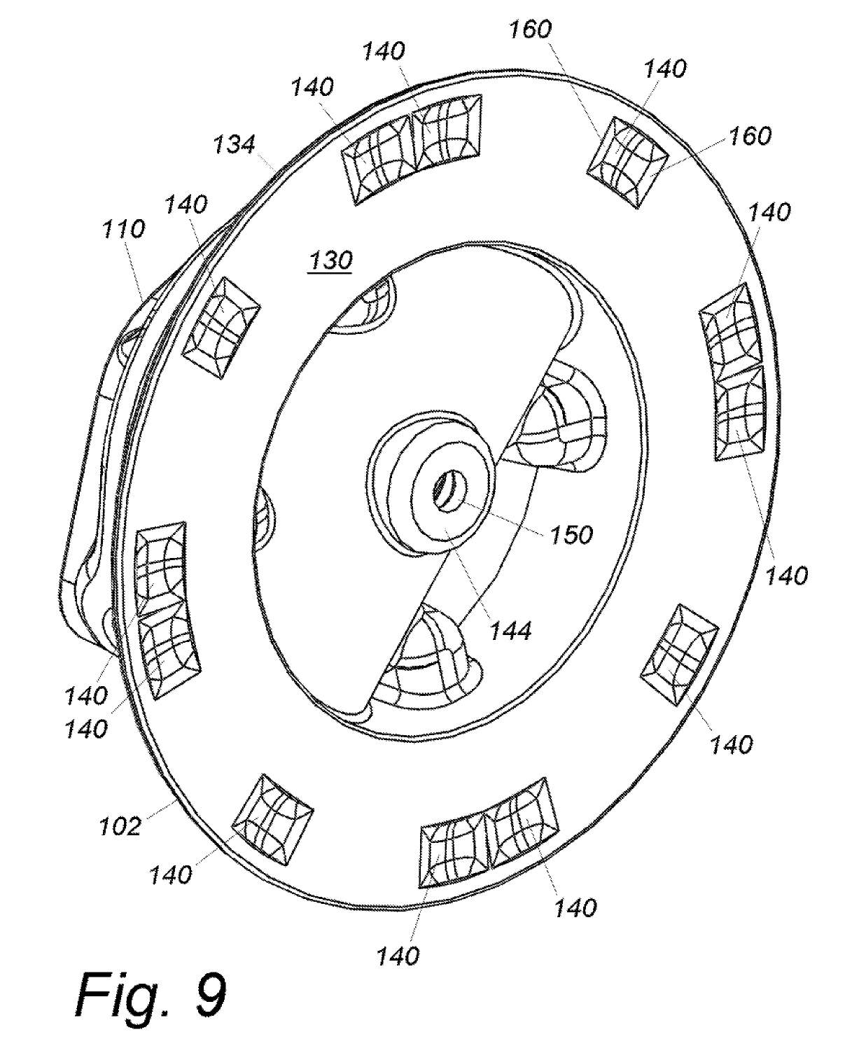

FIG. 9 illustrates mounting interface 102 of rotary coupling 10 showing interfacing surface 130 of flange 134 having notches 140 of interengageable detent-type engaging means 122. Here, interfacing surface 130 of flange 134 is formed with a plurality of notches 140. Notches 140 are positioned in different angular patterns and groupings corresponding to four pawls 142 formed in interfacing surface 132 of adjacent flange 136 of body portion 128 positioned substantially at the four principle cardinal directions as disclosed herein.

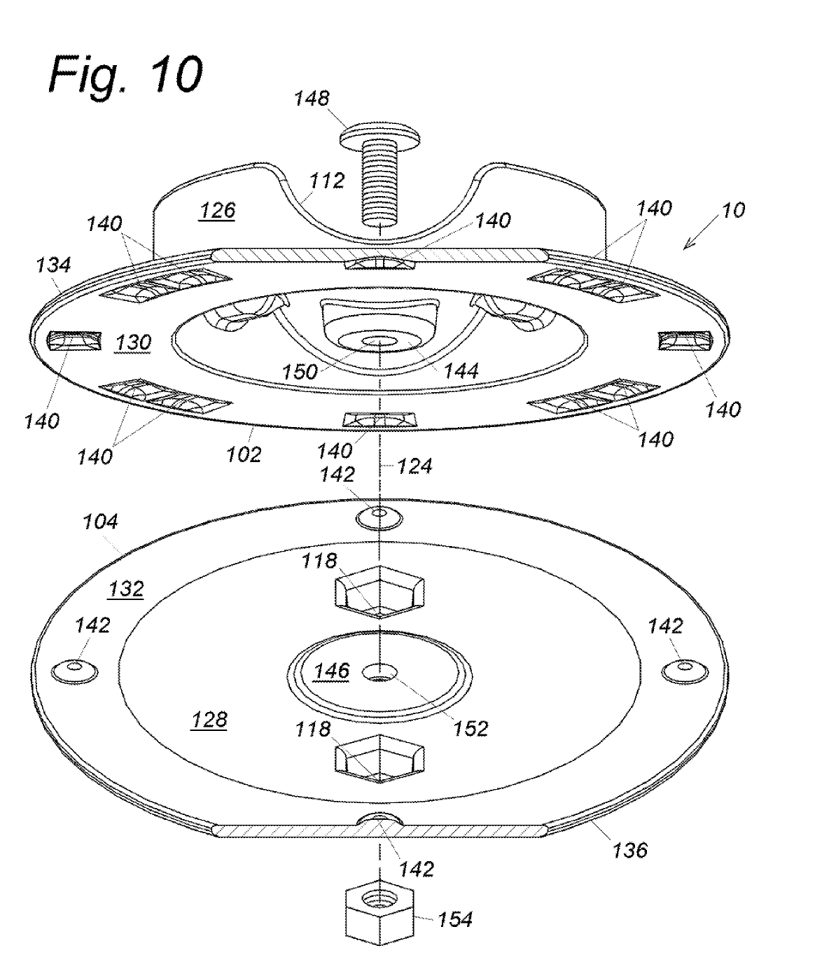

FIG. 10 is an exploded view of rotary coupling 10 with optional cap 110 removed for clarity. Here, pawls 142 are formed in interfacing surface 132 positioned substantially at the four principle cardinal directions. One group or pattern of four notches 140 are formed into interfacing surface 130 of flange 134 substantially at the four complementary principle cardinal directions, whereby mounting interfaces 102 and 104 are rotatable to four different rotational orientations corresponding substantially to the four complementary principle cardinal directions. Additional groups or patterns of notches 140 are formed into interfacing surface 130 of flange 134 in positions between the principle cardinal directions, whereby alternative different corresponding rotational orientations of mounting interfaces 102 and 104 are provided when mounting interfaces 102 and 104 are mated with such different groups or patterns of notches 140.

In assembly, when mutually slidable juxtaposed portions 144 and 146 of respective mounting interfaces 102, 104 are mated, pivot 148 is inserted through matching apertures 150 and 152 aligned along central axis 124, and mating nut 154 coupled thereto when pivot is an optional threaded fastener. Otherwise, alternative means are provided for securing mounting interfaces 102, 104 with mutually slidable juxtaposed portions 144 and 146 aligned along central axis 124. Pivot 148 and mating nut 154, or other securing means, are coupled in a manner that squeezes juxtaposed portions 144 and 146, while maintaining mutual slideablity there between.

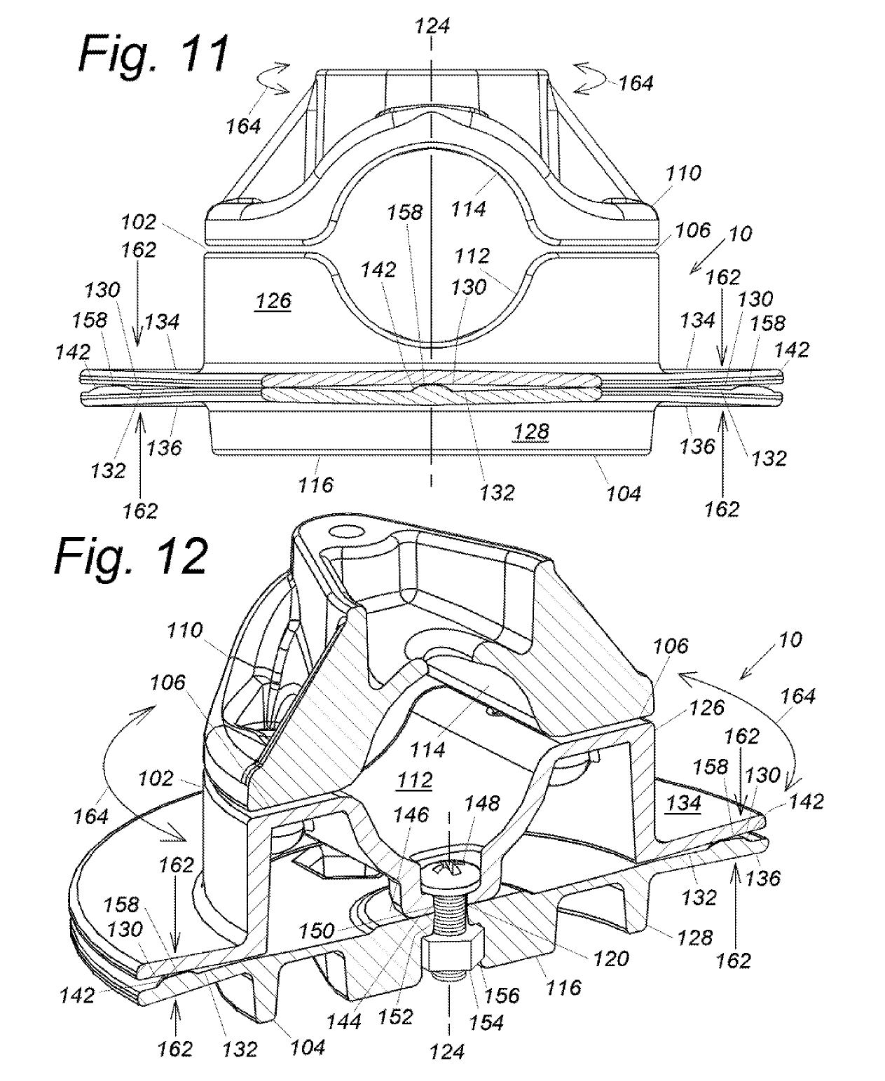

FIG. 11 and FIG. 12 illustrate operation of rotary coupling 10 between mating of pawls 142 and notches 140 of engaging means 122 formed in respective juxtaposed interfacing surfaces 132, 130.

Mounting interfaces 102 and 104 of rotary coupling 10 are formed of a substantially rigid material, such as for example a glass-filled nylon or other moldable material that is substantially rigid upon curing. However, although respective annular flanges 134, 136 of mounting interfaces 102, 104 are formed of a substantially rigid material, such material permits annular flanges 134, 136 to flex slightly under applied pressure, and then resiliently return to their nominally planar structure when such pressured is removed. Accordingly, as illustrated here, when pawls 142 of interengageable detent-type engaging means 122 are positioned between angularly spaced notches 140, pawls 142 contact zones 158 of substantially planar material of interfacing surface 130 of juxtaposed annular flange 134. When pawls 142 are juxtaposed with zones 158 of substantially planar material of interfacing surface 130, flanges 134, 136 are forced apart by the pressure of pawls 140 pushing against planar zones 158 while coupling pivot 148 compresses juxtaposed portions 144 and 146 of respective mounting interfaces 102, 104. Thus, when pawls 142 encounter mating notches 140, pawls 142 enter into and interengage with mating notches 140 to form interengageable detent-type engaging means 122 between flanges 134, 136.

As illustrated in FIG. 9, ramps 160 between notches 140 and zones 158 of substantially planar material of interfacing surface 130 ease entry of pawls 142 into and exit therefrom, while the resilient nature of substantially rigid annular flanges 134, 136 operates to compress pawls 142 into notches 140 (arrows 162) when these components of detent-type engaging means 122 are positioned in juxtaposed alignment. Such compressive pressure (arrows 162) applied by resilient annular flanges 134, 136 effectively retains pawls 142 in notches 140 for interengaging interengageable detent-type engaging means 122 until rotational force (arrows 164) is applied between respective mounting interfaces 102, 104. Rotational force (arrows 164) applied about axis 124 between respective mounting interfaces 102, 104 forces pawls 142 along ramps 160 and out of notches 140 and into zones 158 of substantially planar material of interfacing surface 130 between angularly spaced notches 140.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A rotary coupling, comprising:
first and second mounting interfaces; and
a rotary joint rotatably connecting the first and second interfaces in preselected rotational orientation, the rotary joint comprising selectively engageable engaging means for interengaging the first and second interfaces for maintaining a preselected one of a plurality of alternate rotational orientations.

2. The rotary coupling of claim 1, wherein the selectively engageable engaging means further comprises a plurality of interengageable detents.

3. The rotary coupling of claim 2, wherein the first and second mounting interfaces further comprise adjacent annular flanges having the plurality of interengageable detents positioned between juxtaposed interfacing surfaces thereof.

4. The rotary coupling of claim 1, wherein the rotary joint further comprises mutually slidable juxtaposed portions of the respective mounting interfaces.

5. The rotary coupling of claim 4, wherein the rotary joint further comprises a pivot rotatably coupling the mutually slidable juxtaposed portions of the respective mounting interfaces.

6. The rotary coupling of claim 5, wherein the rotary joint further comprises a pair of apertures mutually aligned along a rotational axis of the rotary joint; and
wherein the pivot is further operational through the pair of apertures.

7. The rotary coupling of claim 6, wherein the pivot of the rotary joint further comprises a threaded coupling.

8. A rotary coupling, comprising:
first and second mounting interfaces comprising cooperating bodies having juxtaposed mutually interfacing surfaces; and
a rotary joint comprising a pivot rotatably coupling the interfacing surfaces of the first and second interfaces in preselected rotational orientation, the rotary joint comprising selectively engageable redundant engaging means for interengaging the interfacing surfaces of the first and second interfaces for maintaining a preselected one of a plurality of alternate rotational orientations.

9. The rotary coupling of claim 8, wherein the selectively engageable redundant engaging means further comprises a plurality of interengageable detents between the interfacing surfaces of the first and second interfaces.

10. The rotary coupling of claim 8, wherein the cooperating bodies of the first and second mounting interfaces further comprise adjacent annular flanges comprising the juxtaposed mutually interfacing surfaces.

11. The rotary coupling of claim 10, wherein the selectively engageable redundant engaging means further comprises a plurality of mating pawls and notches formed in the respective juxtaposed interfacing surfaces.

12. The rotary coupling of claim 8, wherein each of the cooperating bodies of the first and second mounting interfaces further comprises mounting capability.

13. The rotary coupling of claim 12, wherein the mounting capability is further positioned oppositely of the juxtaposed mutually interfacing surfaces of the cooperating bodies of the first and second mounting interfaces.

14. The rotary coupling of claim 13, wherein the mounting capability of one of the cooperating bodies of the first and second mounting interfaces further comprises means for securing to a stanchion.

15. A rotary coupling, comprising:
first and second mounting interfaces comprising cooperating bodies having juxtaposed mutually interfacing surfaces and mounting means; and
a rotary joint comprising a pivot rotatably connecting the interfacing surfaces of the first and second interfaces in preselected rotational orientation, the rotary joint comprising a plurality of selectively engageable redundant detents for interengaging the interfacing surfaces of the first and second interfaces for maintaining a preselected one of a plurality of alternate rotational orientations.

16. The rotary coupling of claim 15, wherein the detents further comprise a plurality of mating pawls and notches formed in respective juxtaposed interfacing surfaces.

17. The rotary coupling of claim 16, wherein the cooperating bodies of the first and second mounting interfaces further comprise adjacent annular flanges that are formed with the respective juxtaposed interfacing surfaces.

18. The rotary coupling of claim 16, wherein the plurality of mating notches further comprises a plurality of different patterns of the notches.

19. The rotary coupling of claim 18, wherein the plurality of different patterns of the notches further comprise notches positioned to mate with the pawls in different angular rotations of the first and second mounting interfaces.
